(19) United States
(12) Patent Application Publication
(10) Pub. No.: US 2025/0187885 A1
(43) Pub. Date: Jun. 12, 2025

(54) HANDLING DEVICE

(71) Applicant: EFFITO PTE. LTD., Singapore (SG)

(72) Inventors: Mu FANG, Singapore (SG); Bingchuan YANG, Singapore (SG); Yujie LU, Singapore (SG); Zhilong LI, Singapore (SG); Jinmei HUANG, Singapore (SG)

(21) Appl. No.: 18/975,269

(22) Filed: Dec. 10, 2024

(30) Foreign Application Priority Data
Dec. 11, 2023 (CN) 202323384702.8

(51) Int. Cl. B66F 9/06; B66F 9/12

(52) U.S. Cl. CPC B66F 9/063; B66F 9/12

(57) ABSTRACT

By providing a 3D laser radar and a camera on a fork assembly of the handling device, the 3D laser radar and the camera can move relative to a device body of the handling device along with the fork assembly. When the 3D laser radar and the camera move along with the fork assembly to a position corresponding to an object, the 3D laser radar collects 3D point cloud data of the object and the camera collects image data of the object, and a controller of the handling device can determine, based on the 3D point cloud data, pose information of the object, and determine, based on the image data, a fork insertion position of the object, and control, based on the pose information and the fork insertion position, the fork assembly to align with the fork insertion position of the object to pick up the object.

### CROSS REFERENCE TO RELATED APPLICATIONS

This application claims priority to Chinese Patent Application No. 202323384702.8 filed on Dec. 11, 2023, the entire content of which is incorporated herein by reference.

### TECHNICAL FIELD

The application relates to the technical field of handling device, and in particular to a handling device.

### BACKGROUND

In the related arts, a Two-Dimensional (2D) laser radar is usually mounted on a handling device to transmit a signal to a to-be-handled object and receive a reflected signal generated by the to-be-handled object by reflecting the transmitted light; based on a comparison result of the transmitted signal and the reflected signal, the 2D laser radar generates point cloud data corresponding to the to-be-handled object, where the point cloud data reflects a pose (including position and pose) of the to-be-handled object; in this case, the handling device can adjust fork based on the pose of the to-be-handled object to align with the to-be-handled object, thereby handling the to-be-handled object.

### SUMMARY

Embodiments of the application disclose a handling device that can ensure that a fork assembly of the handling device can accurately pick up a to-be-handled object, thereby improving an efficiency of picking up the to-be-handled object.

Embodiments of the application disclose a handling device. The handling device includes a device body; a fork assembly movably disposed on the device body and configured to pick up a to-be-handled object; a three dimensional (3D) laser radar on the fork assembly and configured to collect 3D point cloud data of the to-be-handled object; a camera on the fork assembly and configured to collect image data of the to-be-handled object; and a controller communicated with the 3D laser radar, the camera and the fork assembly respectively, and configured to respectively determine, based on the 3D point cloud data and the image data, pose information and a fork insertion position of the to-be-handled object to control the fork assembly to move, so as to enable the fork assembly to align with the fork insertion position of the to-be-handled object.

In the handling device provided by the embodiments of the application, the 3D laser radar and the camera are on the fork assembly, such that the 3D laser radar and the camera can move relative to the device body with the fork assembly. When the 3D laser radar and the camera move to a position corresponding to the to-be-handled object with the fork assembly, the 3D laser radar can collect the 3D point cloud data of the to-be-handled object and the camera can collect the image data of the to-be-handled object; the controller can determine, based on the 3D point cloud data, the pose information of the to-be-handled object, and the controller can determine, based on the image data, the fork insertion position of the to-be-handled object, and further the controller can control, based on the pose information and the fork insertion position of the to-be-handled object, the fork assembly to align with the fork insertion position of the to-be-handled object, so as to pick up the to-be-handled object.

In the handling device provided by the embodiments of the application, the camera is provided to obtain the image data that is less affected by object interference, meanwhile, the 3D laser radar is provided to obtain the 3D point cloud data of the to-be-handled object; therefore, the controller can determine, based on the 3D point cloud data, information of the to-be-handled object in a vertical direction, in other words, the controller can receive less-interfered and richer information of the to-be-handled object by using the camera and the 3D laser radar, thereby improving the identification accuracy for the pose and the fork insertion position of the to-be-handled object, ensuring that the fork assembly of the handling device can accurately pick up the to-be-handled object, and improving the picking up efficiency of the handling device.

### BRIEF DESCRIPTION OF DRAWINGS

In order to more clearly describe the technical solutions of the embodiments of the application, brief introduction will be made to the drawings required for descriptions of the embodiments. Apparently, the drawings described herein are only some embodiments of the application. Those skilled in the arts can obtain other drawings based on these drawings without carrying out creative work.

FIG. 1 is a schematic diagram illustrating a stereoscopic structure of a to-be-handled object and a handling device according to embodiments of the application.

FIG. 2 is a schematic diagram illustrating a stereoscopic structure of a handling device in another view angle according to embodiments of the application.

FIG. 3 is a partially-enlarged view of a position A in FIG. 2.

FIG. 4 is a structural schematic diagram illustrating a communication connection relationship of a handling device according to embodiments of the application.

FIG. 5 is a schematic diagram illustrating a stereoscopic structure of a handling device in another view angle according to embodiments of the application.

FIG. 6 is a simple diagram illustrating a first structure of a to-be-handled object and a handling device according to embodiments of the application.

FIGS. 7A to 7B are simple diagrams illustrating a second structure of a to-be-handled object and a handling device according to embodiments of the application.

FIGS. 8A to 8B are simple diagrams illustrating a third structure of a to-be-handled object and a handling device according to embodiments of the application.

FIG. 9 is a structural schematic diagram illustrating a communication connection relationship of another handling device according to embodiments of the application.

FIG. 10 is a schematic diagram illustrating another stereoscopic structure of a to-be-handled object and a handling device according to embodiments of the application.

FIG. 11 is a schematic diagram illustrating a side view structure of a handling device according to embodiments of the application.

FIG. 12 is a structural schematic diagram illustrating a body part and an anti-collision strip according to embodiments of the application.

FIG. 13 is a structural schematic diagram illustrating a lateral movable component according to embodiments of the application.

### DETAILED DESCRIPTION

In order to help understand the application, the application will be more fully described below by referring to the drawings. The embodiments of the application are given in the accompanying drawings. However, the application can be implemented in many different forms and thus not limited to the embodiments described herein. To the contrary, these embodiments are provided to make the contents of the application more thorough and comprehensive.

Unless otherwise defined, all technical and scientific terms used herein have the same meanings as those skilled in the arts generally understand. The terms used in the specification of the application are used only for the purpose of describing specific embodiments rather than for limiting the application.

It can be understood that, the terms such as “first” and “second” used in the application can be used to describe various elements herein but these elements are not limited by these terms. These terms are only used to distinguish one element from another one.

It can be understood that the “connection” in the following embodiments shall be understood as “electrical connection” “communication connection” or the like if electrical signal or data is transferred between the circuits, modules, units connected.

In use, the terms “one,” “a,” and “the said/the” in singular forms shall include plurality unless otherwise clearly indicated. It shall also be clearly understood that the terms “include/comprise” or “have” indicate presence of the described features, integers, steps, operations, components, parts or their combinations but do not preclude the possibility of presence or addition of one or more other features, integers, steps, operations, components, parts or their combinations. Further, the terms “and/or” used in the application include any or all combinations of related listed items.

A two dimensional (2D) laser radar is disposed on the handling device to determine a pose (position and pose) of a to-be-handled object. The 2D laser radar performs scanning only on a plane to obtain 2D scanning data, and thus the fork of the handling device cannot accurately pick up the to-be-handled object, leading to low picking up efficiency of the handling device picking up the to-be-handled object. Practices show that when the handling device in the related arts picks up a to-be-handled object, the light transmitted by the 2D laser radar may be reflected by an interference object, and the point cloud data generated by the 2D laser radar is not consistent with the actual situations of the to-be-handled object. In this case, the handling device cannot accurately pick up the to-be-handled object, thereby affecting the picking up efficiency of the handling device.

The inventor found through researches that most of the to-be-handled objects are externally wrapped with a protective film (e.g. plastic film). For example, for soft-packaged goods, due to rigidity or height of the goods, the goods may tip over. Therefore, the goods and pallets may be wrapped and reinforced with a film by a film wrapping machine or by hand before handling. However, the protective film wrapped on the outside of the to-be-handled object will cover the fork insertion position of the to-be-handled object. When the laser radar transmits signals to the to-be-handled object, due to the reflection of the protective film, the point cloud data generated by the laser radar may include the point cloud data of the region corresponding to the fork insertion position of the to-be-handled object. Therefore, the handling device cannot identify the fork insertion position on the to-be-handled object, and thus the fork of the handling device cannot be accurately inserted into the fork insertion position of the to-be-handled object, thereby affecting the picking up efficiency of the handling device picking up the to-be-handled object.

In view of the above, embodiments of the application disclose a handling device that can ensure that a fork assembly of the handling device can accurately pick up a to-be-handled object, thereby improving an efficiency of picking up the to-be-handled object. The handling device may be, for example, an unmanned forklift.

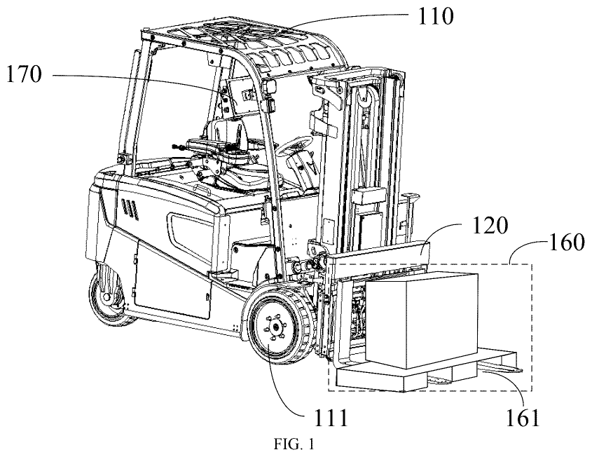

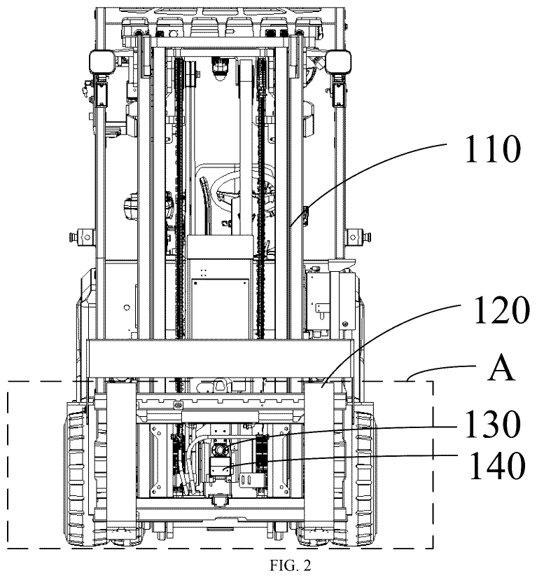

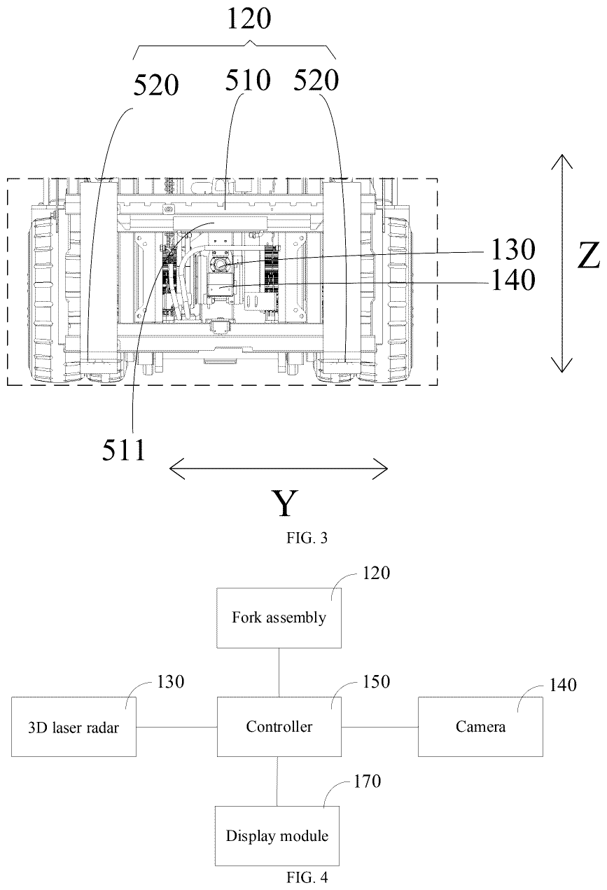

With reference to FIG. 1 to FIG. 4, FIG. 1 is a stereoscopic structural schematic diagram illustrating a handling device according to embodiments of the application; FIG. 2 is a stereoscopic structural schematic diagram illustrating a handling device at another view angle according to embodiments of the application; FIG. 3 is a partially-enlarged diagram of a position A in FIG. 2; FIG. 4 is a structural schematic diagram illustrating a communication connection relationship of a handling device according to embodiments of the application. As shown in FIG. 1 to FIG. 4, the handling device includes a device body 110, a fork assembly 120, a three-dimensional laser radar (3D laser radar) 130, a camera 140, and a controller 150. The fork assembly 120 is movably disposed on the device body 110, and the 3D laser radar 130 and the camera 140 are both on the fork assembly 120. The controller 150 is communicated with the 3D laser radar 130, the camera 140 and the fork assembly 120 respectively. The fork assembly 120 is configured to pick up a to-be-handled object 160. For example, the fork assembly 120 may be inserted into a fork insertion position of the to-be-handled object 160 to pick up the to-be-handled object 160. The 3D laser radar 130 is configured to collect 3D point cloud data of the to-be-handled object 160, the camera 140 is configured to collect image data of the to-be-handled object 160, and the controller 150 is configured to determine, based on the 3D point cloud data, pose information of the to-be-handled object 160, and the controller 150 is configured to determine, based on the image data, the fork insertion position of the to-be-handled object 160, so as to control the fork assembly 120 to align with the fork insertion position of the to-be-handled object 160.

It should be noted that the handling device may be configured to handle the to-be-handled object 160, and the to-be-handled object 160 has at least one fork insertion position, such that the fork assembly 120 can pick up the to-be-handled object 160 by using the fork insertion position, so as to handle the to-be-handled object 160. For example, the fork insertion position of the to-be-handled object 160 has at least one insertion hole 161, and the fork assembly 120 may be inserted into the insertion hole(s) 161 to pick up the to-be-handled object 160. The to-be-handled object 160 may include a pallet and a goods unit on the pallet, and the to-be-handled object 160 may include one or more pallets (e.g. a pallet group formed by stacking multiple pallets). The to-be-handled object 160 may only include a goods unit, where the insertion hole 161 is formed in the to-be-handled object 160 (for example, the goods unit includes multiple pieces of goods which are stacked in such a way that there is a gap between goods to form the insertion hole 161). It can be understood that when the to-be-handled object 160 includes a pallet, the insertion hole 161 is formed between two adjacent bearer supporting brackets of the pallet, and the insertion hole 161 of the pallet is the insertion hole 161 of the to-be-handled object 160. The fork assembly 120 may be moved relative to the device body 110 under the control of the controller 150, for example, rotated relative to the device body 110 or moved along a vertical direction Z, such that the 3D laser radar 130 can collect the 3D point cloud data of the to-be-handled object 160, and the camera 140 can collect the image data of the to-be-handled object 160, and the fork assembly 120 can align with the fork insertion position of the to-be-handled object 160. The device body 110 may include at least one wheel 111, such that the device body 110 can move on road surface and drive the fork assembly 120 to insert into the fork insertion position of the to-be-handled object 160, thereby realizing the handling of the to-be-handled object 160. The 3D laser radar 130 may transmit light and receive reflected light formed by the to-be-handled object 160 by reflecting the transmitted light, and based on a comparison result between the transmitted light and the reflected light, generate 3D point cloud data, where the 3D point cloud data is configured to indicate a pose, a shape and the like of the to-be-handled object 160. Illustratively, the camera 140 may receive the light reflected by the to-be-handled object 160 and perform imaging based on the reflected light to obtain a taken image corresponding to the to-be-handled object 160. Optionally, the camera 140 may include a video camera.

In this embodiment, the camera 140, for example, the video camera, may present a picture (video) of a surrounding environment by collecting light reflected by the surrounding environment. In the embodiment, the camera 140 performs detection on the to-be-handled object 160 and the collected image data is less affected by the protective film, that is, the image data is less affected by interference. Therefore, the image data reflects the shape characteristics of the to-be-handled object 160 well, such that the controller 150 can determine the fork insertion position (e.g. the position of insertion hole on the to-be-handled object 160) of the to-be-handled object 160 based on the image data collected by the camera 140. The 3D laser radar 130 transmits light to the surrounding environment and receives reflected light formed by an object in the surrounding environment by reflecting the transmitted light, and the 3D laser radar 130 calculates a time difference and a phase difference between the transmitted light and the reflected light based on the known light speed to determine a distance between the 3D laser radar 130 and the object in the surrounding environment, and then the 3D laser radar 130 measures an angle of the object by horizontal rotating scanning or phase controlled scanning to obtain the reflected light of different pitch angles, and thus obtain information of the object in the surrounding environment in the vertical direction Z. The 3D point cloud data generated by the 3D laser radar 130 performing detection on the to-be-handled object 160 can reflect the pose information of the to-be-handled object 160 in three-dimensional space. Compared with the 2D laser radar, the 3D laser radar 130 can realize accurate collection of the 3D point cloud data in the vertical direction Z, and thus the controller 150 can obtain richer pose information of the to-be-handled object 160 from the 3D laser radar 130. The controller 150 can determine, based on the image data of the to-be-handled object 160, the fork insertion position of the to-be-handled object 160, and the controller 150 can control the fork assembly 120 to align with the fork insertion position. The controller 150 can determine, based on the 3D point cloud data of the to-be-handled object 160, the pose of the to-be-handled object 160, and the controller 150 can adjust the pose of the fork assembly 120 to make the pose of the fork assembly 120 to correspond to the pose of the to-be-handled object 160, such that when the fork assembly 120 is inserted into the fork insertion position (the insertion hole 161), the fork assembly 120 will not collide with the to-be-handled object 160. In this way, the fork assembly 120 is accurately inserted into the insertion hole 161, which ensures that the fork assembly 120 of the handling device can accurately pick up the to-be-handled object 160.

It should be noted that, when the handling device moves to a handling position corresponding to the to-be-handled object 160, if the 3D point cloud data collected by the 3D laser radar fails to indicate the pose of the to-be-handled object 160, or the image data collected by the camera 140 fails to indicate the fork insertion position of the to-be-handled object 160, the controller 150 can control the fork assembly 120 to move to adjust the positions of the 3D laser radar 130 and the camera 140 until the 3D laser radar 130 can collect the 3D point cloud data indicating the pose of the to-be-handled object 160, and the camera 140 can collect the image data indicating the fork insertion position of the to-be-handled object 160. That is, the controller 150 can determine the pose information and the fork insertion position of the to-be-handled object 160.

It should be noted that the 3D point cloud data of the to-be-handled object 160 can be used to indicate the pose of the to-be-handled object 160, and the image data of the to-be-handled object 160 can be used to indicate the fork insertion position of the to-be-handled object 160. The determination of whether the 3D point cloud data collected by the 3D laser radar can indicate the pose of the to-be-handled object, and whether the image data collected by the camera 140 can indicate the fork insertion position of the to-be-handled object can be determined manually or by the controller 150.

In an example, the handling device may further include a display module 170 communicated with the controller 150. The display module 170 may include a touch display screen. The controller 150 sends the 3D point cloud data and the image data to the display module 170, and the display module 170 can display the 3D point cloud data and the image data. The handling personnel may, based on the 3D point cloud data displayed on the display module 170, determine whether the 3D point cloud data collected by the 3D laser radar 130 can indicate the pose of the to-be-handled object 160, and based on the image data displayed on the display module 170, determine whether the image data collected by the camera 140 can indicate the fork insertion position of the to-be-handled object 160. When the 3D point cloud data collected by the 3D laser radar 130 fails to indicate the pose of the to-be-handled object 160, or the image data collected by the camera 140 fails to indicate the fork insertion position of the to-be-handled object 160, the handling personnel can indicate the controller 150 to control the fork assembly 120 to move until the 3D point cloud data displayed by the display module 170 can indicate the pose of the to-be-handled object 160 and the image data can indicate the fork insertion position of the to-be-handled object 160. At this time, the handling personnel can stop indicating the controller 150 to control the fork assembly 120 to move, and can input a control instruction into the controller 150 to indicate the controller 150 to control, based on the 3D point cloud data and the image data of the to-be-handled object 160, the fork assembly 120 to move to make the fork assembly 120 to align with the fork insertion position of the to-be-handled object 160.

In another example, the controller 150 may be configured with a first identification model and a second identification model. The first identification model is configured to identify whether the 3D point cloud data includes data corresponding to the to-be-handled object 160, and the second identification model is configured to identify whether the image data includes data corresponding to the to-be-handled object 160. When the 3D point cloud data includes the data corresponding to the to-be-handled object 160, it can be thought that the controller 150 may determine the pose information of the to-be-handled object 160 based on the 3D point cloud data, that is, the 3D point cloud data collected by the 3D laser radar 130 can indicate the pose of the to-be-handled object 160. Similarly, when the image data includes the data corresponding to the to-be-handled object 160, it can be thought that the controller 150 can determine the fork insertion position of the to-be-handled object based on the image data, that is, the image data collected by the camera 140 can indicate the fork insertion position of the to-be-handled object 160. In this example, by using the controller 150 configured with the first identification model and the second identification model, the controller 150 can automatically determine whether the 3D point cloud data collected by the 3D laser radar 130 and the image data collected by the camera 140 satisfy requirements, namely, determine whether the 3D point cloud data of the to-be-handled object 160 collected by the 3D laser radar 130 can indicate the pose of the to-be-handled object 160, and whether the image data of the to-be-handled object 160 collected by the camera 140 can indicate the fork insertion position of the to-be-handled object 160, thereby improving the automation degree and handling efficiency of the handling device.

It can be understood that the controller 150 can determine, based on the 3D point cloud data and the image data, the pose information and the fork insertion position of the to-be-handled object 160 respectively, and the controller 150 can control, based on the pose information and the fork insertion position, the fork assembly 120 to move to make the fork assembly 120 to align with the fork insertion position of the to-be-handled object 160. The controller 150 may be, for example, a processor configured with a self-driving system, which may include an industrial personal computer.

In embodiments of the application, by providing the 3D laser radar 130 and the camera 140 on the fork assembly 120, the 3D laser radar 130 and the camera 140 can move relative to the device body 110 along with the fork assembly 120. When the 3D laser radar 130 and the camera 140 move to a position corresponding to the to-be-handled object 160, the 3D laser radar 130 can collect the 3D point cloud data of the to-be-handled object 160, and the camera 140 can collect the image data of the to-be-handled object 160. The controller 150 is respectively communicated with the 3D laser radar 130, the camera 140 and the fork assembly 120, so the controller 150 can obtain richer pose information of the to-be-handled object 160 from the 3D laser radar, obtain the fork insertion position of the to-be-handled object 160 from the camera 140, adjust the pose of the fork assembly 120 and control the fork assembly 120 to align with the fork insertion position of the to-be-handled object 160, so as to pick up the to-be-handled object 160 through the fork assembly 120. In this way, it can be ensured that the fork assembly 120 of the handling device can accurately pick up the to-be-handled object 160, thereby improving the picking up efficiency of the handling device picking up the to-be-handled object 160.

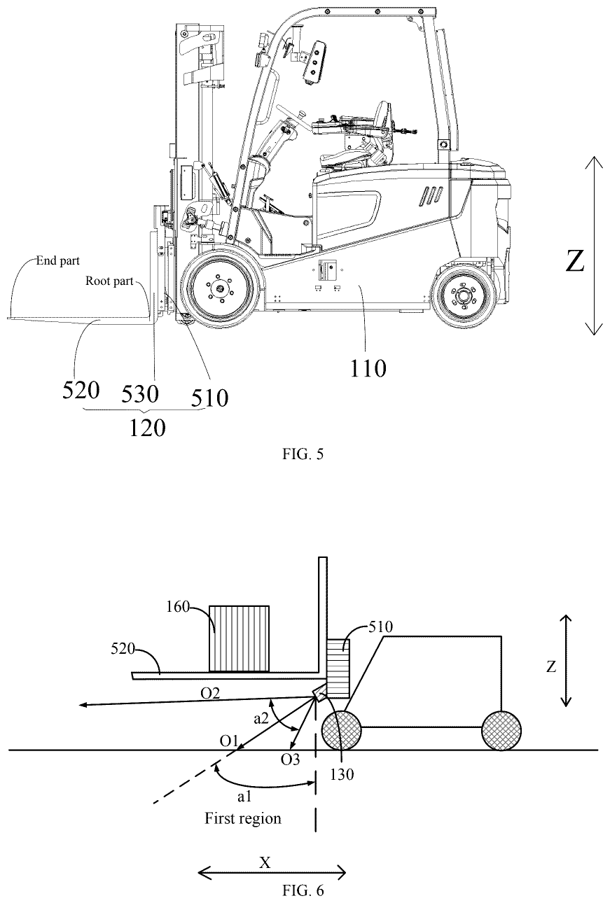

As shown in FIG. 5, it shows a stereoscopic structural schematic diagram illustrating a handling device in another view angle according to embodiments of the application. In the embodiment, taking the fork insertion position of the to-be-handled object 160 being an insertion hole 161 as an example, as shown in FIG. 5, the fork assembly 120 may include a movable component 510 and at least one fork 520, where the fork 520 is connected with the movable component 510. The movable component 510 is on the device body 110 and communicated with the controller 150. The movable component 510 is configured to drive the fork 520 to move relative to the device body 110. The fork 520 is inserted into the insertion hole 161 of the to-be-handled object 160. The 3D laser radar 130 and the camera 140 are both on the movable component 510 and below the fork 520 in a vertical direction Z.

It should be noted that the fork assembly 120 may include at least one fork 520 with a size of a cross section equal to a size of the insertion hole 161 or less than the size of the insertion hole 161. Each fork 520 of the at least one fork 520 is connected with the movable component 510, and the movable component 510 can, under the control of the controller 150, drive the fork 520 to move relative to the device body 110. The 3D laser radar 130 and the camera 140 are both on the movable component 510, and the movable component 510 can drive the 3D laser radar 130 and the camera 140 to move relative to the device body 110, for example, the movable component 510 can drive the 3D laser radar 130 and the camera 140 to move relative to the device body 110 in the vertical direction Z to ensure that the 3D laser radar 130 can collect the 3D point cloud data of the to-be-handled object 160 and the camera 140 can collect the image data of the to-be-handled object 160.

In some embodiments, the fork assembly 120 may further include a fixing part 530 connected with the fork 520. In some embodiments, the fixing part 530 and the fork 520 are of integrated molding structure. The fixing part 530 is connected with the movable component 510. The movable component 510 can, under the control of the controller 150, drive the fixing part 530 and the fork 520 to move relative to the device body 110. In the embodiment, by providing the fixing part 530 connected with the fork 520, a connection area of the fork 520 with the movable component 510 is increased, such that the connection reliability between the fork 520 and the movable component 510 can be improved.

In the embodiment, the 3D laser radar 130 and the camera 140 are at a first position of the movable component 510, where the first position is a position below the fork 520 in the vertical direction Z in the movable component 510. Since the to-be-handled object 160 is borne on the fork 520, an upper region part of the to-be-handled object 160 above the fork 520 in the vertical direction Z is more than a lower region part of the to-be-handled object 160 below the fork 520 in the vertical direction Z. By providing the 3D laser radar 130 and the camera 140 at the first position, if the to-be-handled object 160 collides with the movable component 510, there will be a low possibility that the 3D laser radar 130 and the camera 140 collide with the to-be-handled object 160. In this way, the reliability of the 3D laser radar 130 and the camera 140 can be improved.

In an embodiment, a scanning region of the 3D laser radar 130 includes a first region corresponding to a travel road surface ahead of a front end of the handling device, and the controller 150 may be configured to determine, based on the 3D point cloud data, whether a suspended position is present in the first region. It should be noted that the first region is a road surface region in a region where an end of the device body 110 connected with the movable component 510 is located. When the 3D laser radar 130 is at the first position, the scanning region of the 3D laser radar 130 may be adjusted to enable the scanning region of the 3D laser radar 130 to include the first region corresponding to the travel road surface ahead of the front end of the handling device. With reference to FIG. 6, when the handling device travels along a travel direction X, since the 3D laser radar 130 is at the first position of the movable component 510, a light beam transmitted by the 3D laser radar 130 is irradiated on the region where the front end (an end of the device body 110 connected with the movable component 510) of the handling device is located. The 3D point cloud data collected by the 3D laser radar 130 can reflect road surface information of the corresponding travel road surface in the region where the front end of the handling device is located. When there is a suspended position in the travel road surface, for example, a road surface depression, or a suspended region below the platform, the 3D point cloud data corresponding to the suspended position in the 3D point cloud data collected by the 3D laser radar 130 is null. That is, the controller 150 can determine whether there is a case that no point cloud data is distributed in the 3D point cloud data, and the position of the travel road surface corresponding to the region without point cloud data distribution is the suspended position. The controller 150 controls the handling device to bypass the suspended position, so as to realize the anti-fall function of the handling device, improving the safety and reliability of the handling device. The 3D laser radar 130 can be used to realize three-dimensional collection. Compared with use of the 2D laser radar, the controller 150 can determine a larger environmental region (from a planar region to a stereoscopic region, e.g. from a 2D region to a 3D region), thereby further improving the safety of the handling device.

In an embodiment, the fork 520 include a root part and an end part. The scanning region of the 3D laser radar includes a second region where the root part of the fork 520 is located and a third region corresponding to the end part of the fork 520; the controller 150 is further configured to determine, based on the 3D point cloud data, relative position information between the to-be-handled object 160 and the fork 520.

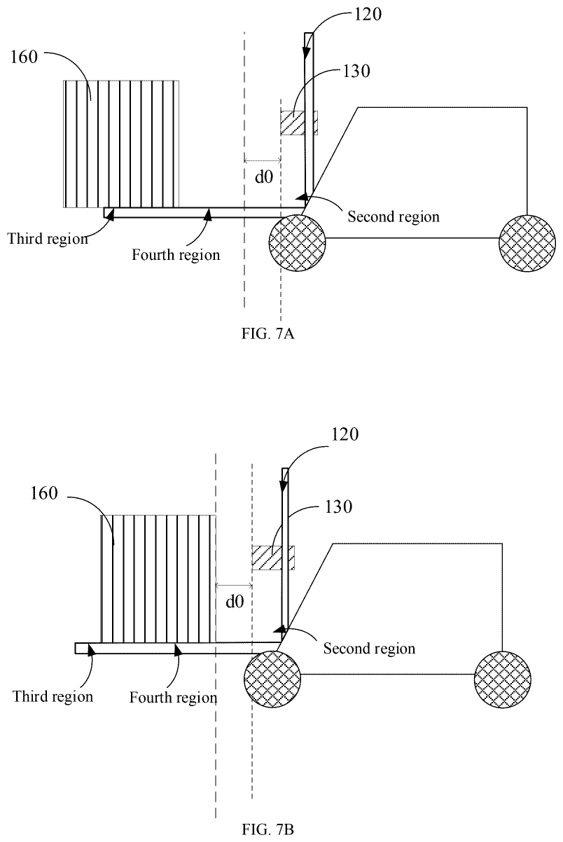

It should be noted that the root part of the fork 520 is a part close to the movable component 510 in the fork 520, and the end part of the fork 520 is a part away from the movable component 510 in the fork 520. As shown in FIG. 7A, when a contact area between the to-be-handled object 160 and the fork 520 is small, there may be a phenomenon that the to-be-handled object 160 easily falls off the fork 520 in the process of handling the to-be-handled object 160 by the handling device. In order to ensure the handling safety, as shown in FIG. 7B, the fork 520 is required to insert into a certain depth of the insertion hole 161 of the to-be-handled object 160.

In the embodiment, the 3D laser radar 130 is adjusted to make the scanning region of the 3D laser radar 130 to include the second region, that is, to include the region where the root of the fork 520 is located, such that the controller 150 can determine, based on the 3D point cloud data collected by the 3D laser radar 130, the relative position between the to-be-handled object 160 and the fork 520, so as to determine the depth that the fork 520 is inserted into the insertion hole 161. In the embodiment, the controller 150 can determine, based on the 3D point cloud data collected by the 3D laser radar 130, the depth that the fork 520 is inserted into the insertion hole 161, therefore, there is no need to set a position detection device. The controller 150 can also determine whether the to-be-handled object 160 is in place horizontally (that is, in the handling process, the to-be-handled object 160 will not fall off the fork 520 due to small contact area between the to-be-handled object 160 and the fork 520). Therefore, the manufacturing costs of the handling device can be reduced.

It should be noted that the scanning region of the 3D laser radar 130 further includes the third region corresponding to the end part of the fork 520. The third region includes a region where the end part of the fork 520 is located and a region ahead of the end part of the fork 520. The ahead of the end part of the fork 520 is a side of the end part of the fork 520 away from the root part of the fork 520. It can be understood that due to limited scanning scope of the 3D laser radar, the region ahead of the end part in the embodiment is a region within a target scope ahead of the end part, where the target scope is related to a scanning scope of the 3D laser radar 130 and a mounting angle (e.g. an included angle between an optical axis direction O1 of the 3D laser radar 130 and the vertical direction Z) of the 3D laser radar 130 and the like. Illustratively, with the mounting angle unchanged, the larger the scanning range of the 3D laser radar is, the larger the target range is. When the handling device gradually approaches the to-be-handled object 160, the to-be-handled object 160 can enter the scanning region of the 3D laser radar 130. At this time, the 3D laser radar 130 can collect position information of the end part of the fork 520 and position information of the insertion holes 161 of the to-be-handled object 160. The controller 150 can determine, based on these position information, whether the fork need to further approach the to-be-handled object 160 and whether the fork 520 will collide with the to-be-handled object 160, and in response to that the fork 520 are about to collide with the to-be-handled object 160, the controller 150 can control the movable component 510 or the handling device to move, so as to avoid collision of the fork 520 with the to-be-handled object 160, thereby realizing safety protection for the end part of the fork 520. In the embodiment, the scanning region of the 3D laser radar 130 on the handling device includes the region where the end part of the fork 520 is located, that is, the 3D laser radar 130 can perform detection on the region where the end part of the fork 520 is located. Therefore, the controller 150 can obtain the position information of the end part of the fork 520 and the position information of the insertion holes 161 of the to-be-handled object 160, and adjust, based on these position information, the pose of the fork 520, thereby realizing safety protection for the end part of the fork 520 and preventing the fork overturning the to-be-handled object 160. As a result, there is no need to provide an additional safety protection sensor on the fork 520, simplifying the structure of the fork 520 and reducing the manufacturing costs.

From the above embodiment, it can be known that, when the scanning region of the 3D laser radar 130 includes the second region and the third region, the handling device can realize the horizontal in-place detection of the to-be-handled object and the end part safety protection function of the fork 520. A structure will be provided below to enable the scanning region of the 3D laser radar 130 to include the second region and the third region, so as to realize the horizontal in-place detection of the to-be-handled object and the end part safety protection function of the fork.

In an embodiment, the handling device can further include a raising and lowering device on the movable component 510 and connected with the 3D laser radar 130. The raising and lowering device is configured to drive the 3D laser radar 130 to move relative to the fork 520 in the vertical direction Z, such that the 3D laser radar can be moved to above the fork in the vertical direction Z, and thus the scanning region of the 3D laser radar 130 can include the second region and the third region. In some embodiments, the scanning region of the 3D laser radar 130 may further include a fourth region communicating with the second region and the third region. It can be understood that the fourth region is a region where a middle portion connecting the root part of the fork 520 and the end part of the fork 520 is located.

It should be noted that the raising and lowering device can be configured to bring the 3D laser radar 130 from a first position to a second position, where the second position is a position above the fork 520 along the vertical direction Z in the movable component 510, that is, the 3D laser radar 130 is moved from the position below the fork 520 in the vertical direction Z to above the fork 520 in the vertical direction Z. Since the raising and lowering device is on the movable component 510 and connected with the 3D laser radar 130, the movable component 510 can drive the raising and lowering device to move relative to the device body 110, and thus the 3D laser radar 130 and the camera 140 can be moved relative to the device body 110. It can be understood that by adjusting a distance between the 3D laser radar 130 and an upper surface of the fork 520 in the vertical direction Z, and/or by adjusting a first included angle between the optical axis direction O1 of 3D laser radar 130 and the vertical direction Z, the scanning region of the 3D laser radar 130 can be adjusted, such that when the 3D laser radar 130 is at the second position, the scanning region of the 3D laser radar 130 can include the second region and the third region. In some embodiments, the raising and lowering device may be further connected with the camera 140 to drive the camera 140 to move together during driving the 3D laser radar 130 to move to the second position. Therefore, there is no need to consider whether the 3D laser radar 130 can be blocked by the camera 140 during the process that the raising and lowering device drives the 3D laser radar 130 to move, reducing the design difficulty of the raising and lowering device.

In some embodiments, the raising and lowering device may include a push rod which can raise and fall and configured to drive the 3D laser radar 130 to move relative to the fork in the vertical direction. The push rod may be an electric push rod. The electric push rod is on the movable component 510 and the 3D laser radar is on the electric push rod. In other embodiments, the push rod that is able to raise and fall may further include a cylinder-driven push rod. The cylinder-driven push rod is on the movable component 510 and the 3D laser radar 130 is on the cylinder-driven push rod. It should be noted that the controller 150 can send different signals to the push rod (for example, send different electric signals to the electric push rod, and send different control signals to the cylinder-driven push rod) to extend or retract the push rod, so as to drive the 3D laser radar 130 to move between the first position and the second position. The moving distance of the push rod should be able to accommodate the movement of the 3D laser radar 130 between the first position and the second position.

It can be understood that the above raising and lowering device may also be in another form and is not limited to the above forms, as long as the 3D laser radar 130 can be moved relative to the fork 520 in the vertical direction Z.

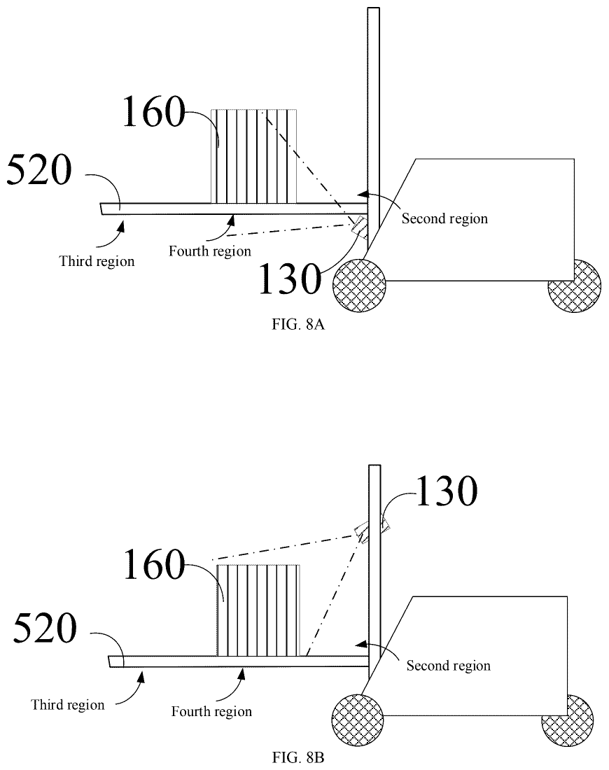

It can be understood that when the 3D laser radar 130 is below the fork 520 in the vertical direction Z, and scans the to-be-handled object 160 (as shown in FIG. 8A), the fork 520 can block the scanning of the 3D laser radar 130 for the to-be-handled object 160, and thus cause interference to the horizontal in-place detection for the to-be-handled object 160 and the end part safety protection for the fork 520. In the embodiment, by providing the raising and lowering device in the handling device, the 3D laser radar 130 can be raised from the first position to the second position (as shown in FIG. 8B), thereby avoiding the scanning region of the 3D laser radar 130 being blocked by the fork 520, and improving the accuracy of the horizontal in-place detection of the to-be-handled object 160 and the end part safety protection of the fork 520.

In an embodiment, the raising and lowering device is communicated with the controller 150, and the controller 150 may also be configured to control, in response to that the 3D laser radar 130 collects the 3D point cloud data of the to-be-handled object 160, the raising and lowering device to bring the 3D laser radar 130 to move to the second position, so as to enable the scanning region of the 3D laser radar 130 to include the second region and the third region. In some embodiments, when the controller 150 receives a control instruction input by a user or identifies that the 3D point cloud data includes the to-be-handled object 160, the controller 150 control the raising and lowering device to drive the 3D laser radar 130 to move to the second position, to enable the scanning region of the 3D laser radar 130 includes the second region and the third region. It should be noted that it can be known from the above that when the controller 150 receives the control instruction input by the user or identifies that the 3D point cloud data includes the to-be-handled object 160, it can be thought that the 3D point cloud data collected by the 3D laser radar 130 can be used to indicate the pose of the to-be-handled object 160, that is, the 3D laser radar 130 collects the 3D point cloud data of the to-be-handled object 160.

In an embodiment, with continuous reference to FIG. 3, the movable component 510 may include a raising and lowering component and a lateral movable component 511. The raising and lowering component is movably disposed on the device body 110 and can be moved relative to the device body in the vertical direction Z; and the lateral movable component 511 is on the raising and lowering component. The 3D laser radar 130 and the camera 140 are both on the raising and lowering component, and the fork 520 is on the lateral movable component 511. The fork 520 can be driven by the lateral movable component 511 to move in a width direction Y of the device body 110. The controller 150 is communicated with the lateral movable component 511 and the raising and lowering component respectively. The controller 150 can further be configured to determine, based on the 3D point cloud data and the image data, a height position of the insertion hole 161 of the to-be-handled object 160 in the vertical direction Z, and control the raising and lowering component to move relative to the device body 110 in the vertical direction Z to drive the fork 520 to move in the vertical direction Z to the height position corresponding to the insertion hole 161 of the to-be-handled object 160. The controller 150 is configured to control the lateral movable component 511 to bring the fork 520 to move in the width direction Y, and determine, based on the 3D point cloud data, a movement distance of the fork 520 in the width direction Y. The raising and lowering component can control the fork 520 to move in the vertical direction Z with a higher accuracy than the raising and lowering device. For example, the raising and lowering component can be an electric push rod or cylinder-driven push rod with higher travel accuracy.

It should be noted that the width direction Y of the device body 110 is perpendicular to the vertical direction Z and perpendicular to the travel direction X of the handling device. From the above, it can be known that the controller 150 can determine, based on the 3D point cloud data collected by the 3D laser radar at the first position and the image data, the pose information of the to-be-handled object 160 and the position of the insertion hole 161, that is, the controller 150 can determine the height position of the insertion hole 161 in the vertical direction Z and a lateral movable position of the insertion hole 161 relative to the device body 110 in the width direction Y. The controller 150 controls the raising and lowering component to move relative to the device body 110 in the vertical direction Z to bring the fork 520 to move in the vertical direction Z to the height position of the insertion hole 161, and control the lateral movable component 511 to drive the fork 520 to move in the width direction Y to make the position of the fork 520 to correspond to the lateral movable position of the insertion holes 161 in the width direction Y. Since the scanning region of the 3D laser radar 130 includes the second region, when the fork 520 is at a different position in the width direction Y, the 3D laser radar 130 collects different 3D point cloud data, that is, the controller 150 can determine, based on the 3D point cloud data, the movement distance of the fork in the width direction Y (or determine the position of the fork 520 in the width direction Y) to determine whether the position of the fork 520 correspond to the lateral movable position of the insertion hole 161 of the to-be-handled object 160 in the width direction Y. In this way, the fork can be accurately controlled to align with the insertion hole 161 of the to-be-handled object 160, so as to handle the to-be-handled object 160. In the embodiment, the controller 150 can determine, based on the 3D point cloud data, the movement distances of the fork 520 in the width direction Y, thereby there is no need for additionally providing a range finder on the handling device, and saving the manufacturing costs of the handling device.

In an embodiment, the handling device may further include a height detection sensor communicated with the controller 150. The height detection sensor is on the fork 520 or the raising and lowering component of the movable component 510 to detect height of the fork in the vertical direction Z. It can be understood that when the height detection sensor is on the raising and lowering component of the movable component 510, since the fork 520 is connected with the lateral movable component 511, and the lateral movable component 511 is connected with the raising and lowering component of the movable component 510, i.e., since the movement of the fork 520 in vertical direction Z is driven under the movement of the raising and lowering component, the height detection sensor on the raising and lowering component can detect the height position of the fork 520 in the vertical direction Z. In some embodiments, the height detection sensor may include a wire drawing encoder.

In the embodiment, the height detection sensor is on the fork 520 or on the raising and lowering component of the movable component 510, such that the controller 150 can determine the position of the fork in the vertical direction Z, and thus accurately adjust the position of the fork 520 in the vertical direction Z to be consistent with the height position of the insertion hole 161 of the to-be-handled object 160 in the vertical direction Z, thereby improving the handling efficiency of the handling device and the picking up accuracy of the handling device.

In the embodiment, by adjusting the position of the fork 520 in the vertical direction Z and the width direction Y by using the raising and lowering component and the lateral movable component 511, the fork 520 can be aligned with the insertion hole 161 of the to-be-handled object 160, thereby there is no need for controlling the handling device to move entirely and improving the picking up efficiency and convenience of the handling device.

With continuous reference to FIG. 6, it shows a schematic diagram of a first structure of a 3D laser radar according to embodiments of the application. As shown in FIG. 6, a first included angle a1 is formed between the optical axis direction O1 of the 3D laser radar 130 and the vertical direction Z, where the first included angle a1 ranges from 45° to 55°. In some embodiments, the first included angle a1 may be 45°, 47°, 49.5°, 52° and 55°.

It should be noted that the 3D laser radar 130 can send a light beam, where the optical axis direction O1 is a direction corresponding to a middle line of the light beam sent by the 3D laser radar 130. It can be understood that if the first included angle a1 is too small, since the to-be-handled object 160 has a distance from the movable component 510, even when the movable component 510 ascends to the highest position, the 3D laser radar 130 cannot collect the complete 3D point cloud data of the to-be-handled object 160; if the first included angle a1 is too large, the scanning region of the 3D laser radar 130 includes the fork 520, that is, the 3D point cloud data includes the information corresponding to the fork 520, and thus interference can be brought to the controller 150 determining the pose information of the to-be-handled object 160 based on the 3D point cloud data.

In the embodiment, by setting the range of the first included angle a1 being 45° to 55°, it can be ensured that driven by the movable component 510, the 3D laser radar 130 can collect the 3D point cloud data of the to-be-handled object 160, and it can also be avoided that the 3D point cloud data carries interference information corresponding to the fork 520. Therefore, the picking up accuracy of the handling device can be improved.

In some embodiments, a vertical field of view angle a2 of the 3D laser radar ranges from 40° to 65°. It can be understood that the 3D laser radar can send a light beam consisting of multiple rays (as shown in FIG. 6, central ray O1, ray 02 and ray 03); an included angle between two rays at edges (e.g., rays 02 and 03) is the vertical field of view angle a2 of the 3D laser radar 130. In some embodiments, the vertical field of view angle a2 of the 3D laser radar 130 may be 40°, 50°, 59° and 65°. It can be understood that the number of the rays is determined by the attributes of the 3D laser radar 130, and the proper 3D laser radar 130 can be selected based on actual situations such that the picking up accuracy of the handling device meets the requirements.

In an embodiment, when the raising and lowering device drives the 3D laser radar 130 to move to above the fork 520 in the vertical direction Z, a distance between the 3D laser radar 130 and the upper surface of the fork 520 in the vertical direction Z is greater than or equal to 100 mm.

It should be noted that under the control of the controller 150, the raising and lowering device drives the 3D laser radar 130 to move to the second position, where a distance between the second position and the upper surface of the fork 520 in the vertical direction Z is greater than or equal to 100 mm. In the embodiment, the first included angle a1 between the optical axis direction O1 of the 3D laser radar 130 and the vertical direction Z ranges from 45° to 55°; when the 3D laser radar 130 moves to the second position, the scanning region of the 3D laser radar 130 may include the second region where the root part of the fork 520 is located and the third region corresponding to the end part of the fork 520, and thus the handling device can realize safety protection for the end part of the fork and the in-place detection function for the to-be-handled object.

In an embodiment, when the 3D laser radar 130 is at the first position, the controller 150 can determine, based on the 3D point cloud data and the image data, the pose information and the fork insertion position of the to-be-handled object respectively, and control the fork 520 to move and to make the fork assembly 120 to move to the fork insertion position of the to-be-handled object 160, and control the handling device to perform anti-fall function; when the 3D laser radar 130 is at the second position, the controller 150 can perform, based on the 3D point cloud data and the image data, the safety protection for the end part of the fork 520 and the horizontal in-place detection operation for the to-be-handled object. By controlling the 3D laser radar to be at the first position and second position, it can be ensured that the handling device can pick up the to-be-handled object 160 with high accuracy, and execute anti-fall function, the safety protection for the end part of the fork and the horizontal in-place detection function for the to-be-handled object. When the 3D laser radar 130 is at different positions, the controller 150 can perform different operations, avoiding various mis-operations and improving the picking up reliability of the handling device.

With continuous reference to FIG. 3, in an embodiment, the fork assembly 120 may include two forks 520 that are disposed in a spacing on the movable component 510; the 3D laser radar 130 and the camera 140 are between the two forks 520; the 3D laser radar 130 and the camera 140 are arranged in the vertical direction Z. In some embodiments, as shown in FIG. 3, the camera 140 may be below the 3D laser radar 130 in the vertical direction Z. The camera may also be located at a position different from the FIG. 3, for example, above the 3D laser radar 130 in the vertical direction Z.

It should be noted that the handling device provided by the embodiment includes two forks 520 that are configured to handle the to-be-handled object 160, improving the handling reliability. It can be understood that the 3D laser radar 130 and the camera 140 have a limited scanning region respectively; when the 3D laser radar 130 and the camera 140 are disposed between the two forks 520, compared with the 3D laser radar 130 and the camera 140 being disposed on a fork and away from the other fork, the 3D laser radar 130 a with smaller collection region can also perform collection on the to-be-handled object 160. In some embodiments, the two forks 520 are symmetrical about a line connecting the 3D laser radar 130 and the camera 140, and thus the 3D laser radar 130 with smaller collection region can be used to scan the two forks 520 and the to-be-handled object 160, therefore lowering the requirements for the scanning region of the 3D laser radar 130.

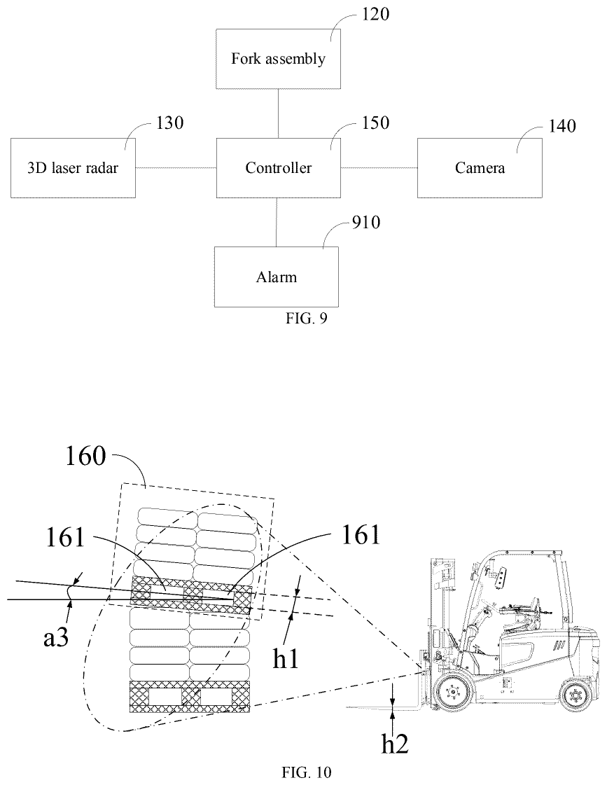

With reference to FIG. 9, it shows a structural schematic diagram illustrating a communication connection relationship of another handling device according embodiments of the application. As shown in FIG. 9, the handling device may further include an alarm 910 communicated with the controller 150. The controller 150 may be configured to control, when, based on the 3D point cloud data, determining that a third included angle between a placement direction of the to-be-handled object 160 and the upper surface of the fork 520 is greater than a preset angle, the alarm 910 to give an alarm.

It should be noted that when the 3D laser radar 130 collects the 3D point cloud data of the to-be-handled object 160 (for example, the 3D laser radar 130 is at the first position), the controller 150 can determine, based on the 3D point cloud data, the third included angle, i.e., the included angle between the placement direction of the to-be-handled object 160 and the upper surface of the fork 520. The placement direction of the to-be-handled object 160 is a direction parallel to a contact surface of the to-be-handled object 160 with the fork 520 and perpendicular to a fork insertion direction of the insertion hole 161; the fork insertion direction of the insertion holes 161 is a direction that the fork is inserted into the insertion hole 161; the upper surface of the fork 520 is a surface that is in contact with the to-be-handled object 160. The preset angle is used to determine whether the fork 520 can stably take the to-be-handled object 160. Namely, when the third included angle a3 between the upper surface of the fork 520 and the placement direction of the to-be-handled object 160 is less than or equal to the preset angle, the fork 520 can stably pick up the to-be-handled object 160; when the third included angle a3 between the upper surface of the fork 520 and the placement direction of the to-be-handled object 160 is greater than the preset angle, the fork 520 may not be able to insert into the insertion hole 161, or when the third included angle a3 between the contact surface of the to-be-handled object 160 and the upper surface of the fork 520 is too large, side-turning accident may easily occur and so on. It can be understood that the contact surface of the to-be-handled object 160 is a surface of the to-be-handled object 160 in contact with the upper surface of the fork 520.

The following descriptions are made with an example in which the to-be-handled object 160 has two insertion holes 161 and the handling device has two forks 520. With reference to FIG. 10, the to-be-handled object 160 to be handled by the handling device is provided with two insertion holes 161 that are spaced apart in the placement direction of the to-be-handled object 160, and the two forks 520 of the fork assembly 120 are inserted into the corresponding insertion holes 161 to realize handling for the to-be-handled object 160. The preset angle is a maximal angle at which the two forks 520 are both inserted into the insertion holes 161 corresponding to the fork 520. Generally, each insertion hole 161 has a height h1 in the vertical direction Z, and each fork 520 has a thickness h2. When the third included angle a3 between the upper surface of the fork 520 and the placement direction of the to-be-handled object 160 is greater than the preset angle, the two forks 520 cannot be inserted into the insertion holes 161 corresponding to the fork 520. The preset angle can be set according to the height h1 of the insertion holes 161 of the to-be-handled object 160 in the vertical direction Z and the thickness h2 of the fork 520.

When the third included angle a3 is greater than the preset angle, it indicates that there may be a risk if the forks 520 are inserted into the insertion holes 161. In the embodiment, the controller 150 can determine, based on the 3D point cloud data, the third included angle a3 between the placement direction of the to-be-handled object 160 and the upper surface of the fork 520, and when the third included angle a3 is greater than the preset angle, control the alarm 910 to give an alarm, so as to enable the handling personnel to know the placement position of the to-be-handled object 160 is not in compliance with standard. In this case, the controller 150 can control the handling device to stop moving forward. After the handling personnel adjusts the placement direction of the to-be-handled object 160, the third included angle a3 is less than or equal to the preset angle, such that the handling device can handle the to-be-handled object 160.

In some embodiments, the alarm 910 may include a luminous device and/or sound playing device. It should be noted that when the alarm 910 include the luminous device, the controller 150 is communicated with the luminous device, and the controller 150 can control, when, based on the 3D point cloud data, determining the third included angle a3 between the placement direction of the to-be-handled object 160 and the upper surface of the fork 520 is greater than the preset angle, the luminous device to emit light. When the alarm 910 includes the sound playing device, the controller 150 is communicated with the sound playing device, and the controller 150 can control, when based on the 3D point cloud data, determining the third included angle a3 between the placement direction of the to-be-handled object 160 and the upper surface of the fork 520 is greater than the preset angle, the sound playing device to play sound. In some embodiments, the luminous device may include a signal lamp. In some embodiments, the sound playing device may include a buzzer.

In the embodiment, by emitting light and/or playing sound, the handling personnel is prompted that the third included angle a3 between the placement direction of the to-be-handled object 160 and the upper surface of the fork 520 is greater than the preset angle, such that the handling personnel performs corresponding processing to enable the third included angle a3 between the placement direction of the to-be-handled object 160 and the upper surface of the fork 520 to be less than or equal to the preset angle. In this way, the handling device can handle the to-be-handled object 160 by the forks 520 inserting into the corresponding insertion holes 161 of the to-be-handled object 160.

In the above embodiments, with the alarm 910 disposed on the handling device, the handling personnel can perform corresponding processing to enable the handling device to handle the processed to-be-handled object 160 with the third included angle a3 between the placement direction and the upper surface of the fork 520 being greater than the preset angle. In the following embodiments, there is provided another handling device which is provided with a rotator to bring the forks 520 to rotate. In this case, even if the third included angle a3 between the placement direction of the to-be-handled object 160 and the upper surface of the fork 520 is greater than the preset angle, the handling device can stably handle the to-be-handled object 160 by using the fork 520.

In an embodiment, the movable component 510 may include a rotator and/or a raising and lowering component. The raising and lowering component is movably disposed on the device body 110 and can move relative to the device body 110 in the vertical direction Z; the rotator is rotatably connected to the raising and lowering component. The 3D laser radar 130 and the camera 140 are both on the raising and lowering component, and the two forks 520 are on the rotator and can be rotated under the drive of the rotator. The rotator is, for example, a turntable which can bring the forks 520 to rotate around an axis of the turntable, where the axis of the turntable is parallel to the travel direction X. The 3D laser radar 130 and the camera 140 will not rotate along with the rotation of the rotator. The controller 150 may be communicated with the rotator and/or the raising and lowering component respectively, and the controller 150 can be configured to determine, based on the 3D point cloud data and the image data, the height positions of the insertion holes 161 of the to-be-handled object 160 in the vertical direction Z, and control the raising and lowering component to move relative to the device body 110 in the vertical direction Z to drive the forks 520 to move to the height positions of the insertion holes 161 in the vertical direction Z, and/or, the controller 150 can be configured to determine, based on the 3D point cloud data, the third included angle a3 between the placement direction of the to-be-handled object 160 and the upper surface of the fork 520, and control, based on the third included angle a3, the rotator to rotate and bring the forks 520 to rotate, such that the third included angle a3 between the placement direction of the to-be-handled object 160 and the upper surface of the fork 520 is less than or equal to the preset angle.

It should be noted that reference can be made to the descriptions of the above embodiments for the descriptions of the raising and lowering component and the preset angle, and no redundant descriptions are made herein. As shown in FIG. 10, the controller 150 can determine, based on the 3D point cloud data, the third included angle a3 between the placement direction of the to-be-handled object 160 and the upper surface of the fork 520. When the third included angle a3 is greater than the preset angle, the controller 150 can control the rotator to rotate and bring the forks 520 to rotate and enable the third included angle a3 between the upper surface of the fork 520 and the placement direction of the to-be-handled object 160 to be less than the preset angle, so as to realizing the forks 520 picking up the to-be-handled object 160 stably, thereby handling the to-be-handled object 160. It can be understood that the third included angle a3 is less than or equal to the preset angle, which is a range in which the fork 520 can perform stable picking up operation; when the third included angle a3 is less than or equal to the preset angle, the controller 150 may not control the fork 520 to rotate. In some embodiments, the controller 150 may control the rotator to make the upper surface of the fork 520 to be parallel to the placement direction of the to-be-handled object 160 (that is, the third included angle a3 is 0).

In the embodiment, with the movable component 510 including the raising and lowering component and the rotator on the handling device, the controller 150 can handle the to-be-handled object 160 at a different height in the vertical direction Z as well as handle the to-be-handled object 160 obliquely placed, thereby greatly improving the applicability of the handling device.

In an embodiment, the lateral movable component 511 is on the rotator, and the two forks 520 are both on the lateral movable component 511. The lateral movable component 511 is configured to drive the two forks 520 to move in the width direction Y of the device body 110, so as to adjust a distance between the two forks 520, and/or drive the two forks 520 to move relative to the device body 110 in the width direction Y of the device body 110.

It should be noted that the rotator is rotatably connected with the raising and lowering component, and the lateral movable component 511 is on the raising and lowering component through the rotator. The lateral movable component 511 is moved along with the raising and lowering component in the vertical direction Z and rotated along with the rotation of the rotator, so as to drive the two forks 520 to move in the vertical direction Z and to rotate. It can be understood that the distance between the two insertion holes 161 may be different depending on different to-be-handled objects 160, for example, the distance between the two insertion holes 161 may be different depending on different specifications of pallets. By providing the lateral movable component 511, the distance between the two forks 520 and/or the relative position between the two forks 520 and the device body 110 in the width direction Y can be adjusted, such that the handling device can handle different to-be-handled objects 160, and the forks 520 can be quickly aligned with the insertion holes 161 in the width direction Y, thereby improving the applicability and the picking up efficiency of the handling device.

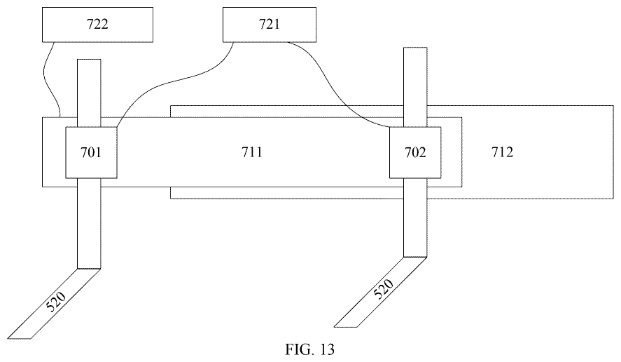

In an embodiment, as shown in FIG. 13, it is a structural schematic diagram illustrating a lateral movable component according to embodiments of the application. The lateral movable component 511 may include a first slide block 701, a second slide block 702, a first guideway 711, a second guideway 712, a first driving component 721 and a second driving component 722. The first slide block 701 and the second slide block 702 are both slidably connected with the first guideway 711. The first slide block 701 is connected with one of the two forks 520 and the second slide block 702 is connected with the other of the two forks 520. The first guideway 711 and the second guideway 712 are slidably connected. The first driving component 721 is connected with the first slide block 701 and the second slide block 702 and drives the first slide block 701 and the second slide block 702 to slide along the first guideway 711. The second driving component 722 is connected with the first guideway 711 and drives the first guideway 711 to slide along the second guideway 712. The second guideway 712 is on the rotator, and the first driving component 721 and the second driving component 722 are both communicated with the controller 150. The controller 150 can be configured to determine, based on the 3D point cloud data, lateral movable positions of the two insertion holes 161 to control the first driving component 721 to drive the first slide block 701 and/or the second slide block 702 to slide along the first guideway 711, and hence drive the two forks 520 to slide, thereby adjusting the first distance between the two forks 520, and/or control the second driving component 722 to drive the first guideway 711 to slide along the second guideway 712 to entirely adjust the positions of the two forks 520 in the width direction Y. In this way, the positions of the two forks 520 in the width direction Y correspond to the lateral movable positions of the two insertion holes 161.

In the embodiment, by providing the raising and lowering component, the rotator and the lateral movable component 511 on the handling device, the forks 520 can be moved relative to the device body 110 in the vertical direction Z and in the width direction Y and rotated, so as to realize the two forks 520 respectively aligning with the insertion holes 161 of the to-be-handled object 160, thereby there is no need for controlling the handling device to make entire movement and improving the picking up efficiency and convenience of the handling device.

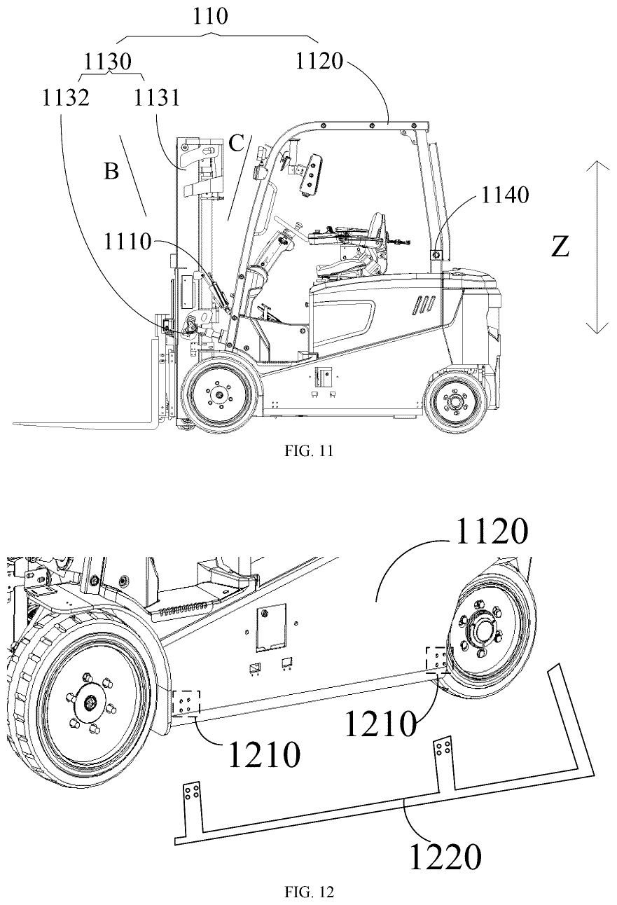

With reference to FIG. 11, it is a schematic diagram illustrating a side view structure of another handling device according to embodiments of the application. As shown in FIG. 11, the device body 110 may include a body part 1120 and a gantry 1130 movably disposed on the body part 1120. The fork assembly 120 is movably disposed on the gantry 1130, and the controller 150 is communicated with the gantry 1130. The controller 150 is further configured to determine, based on the 3D point cloud data, a second included angle between the fork insertion direction of the insertion holes 161 of the to-be-handled object 160 and a horizontal plane, and control the gantry 1130 to move, so as to make an included angle between a length direction of the forks 520 and the horizontal plane to be consistent with the second included angle.

It should be noted that when the 3D laser radar 130 is at the first position, the 3D point cloud data of the to-be-handled object 160 can be collected, and the controller 150 can be configured to determine, based on the 3D point cloud data, the second included angle between the fork insertion direction of the insertion holes 161 of the to-be-handled object 160 and the horizontal plane. The fork insertion direction of the insertion holes 161 is a direction in which the forks 520 are inserted into the insertion holes 161. The gantry 1130 is movably connected with the device body 110, and the gantry 1130 may be tilted forward (as shown by the line segment B in FIG. 11) or tilted backward (as shown by the line segment C in FIG. 11) relative to the device body 110. Since the fork assembly 120 is movably connected with the gantry 1130, when the gantry 1130 is tilted forward or backward relative to the device body 110, the included angle between the length direction of the forks 520 and the horizontal plane may be changed, and the controller 150 can control the gantry 1130 to move to make the included angle between the length direction of the forks 520 and the horizontal plane to be consistent with the second included angle between the fork insertion direction of the insertion holes 161 and the horizontal plane. In this way, the forks 520 can be inserted into the insertion holes 161, so as to realize handling for the to-be-handled object 160. In some embodiments, the raising and lowering component is movably connected to the gantry 1130, and the raising and lowering component can move relative to the gantry 1130 in the vertical direction Z.

In an embodiment, the handling device may include an angle detector 1110 on the gantry 1130. The angle detector 1110 is communicated with the controller 150. The angle detector 1110 may be configured to detect a fourth angle between the gantry 1130 and the vertical direction Z, and the controller 150 may be further configured to determine, based on the fourth angle determined by the angle detector 1110, whether the gantry is tilted to be in place, that is, whether the included angle between the length direction of the forks 520 and the horizontal plane is consistent with the second included angle between the fork insertion direction of the insertion holes 161 and the horizontal plane, thereby realizing accurately picking up the to-be-handled object 160.

In an embodiment, with continuous reference to FIG. 11, one end of the angle detector 1110 is connected with the gantry 1130 and the other end of the angle detector 1110 is connected with the body part 1120. The angle detector 1110 may extend or retract along with the forward or backward tilt of the gantry 1130, and the angle detector 1110 can determine, based on a length of the extension or retraction of the angle detector 1110, a fourth angle between the gantry 1130 and the vertical direction Z.

In an embodiment, with continuous reference to FIG. 11, the gantry 1130 may include a gantry body 1131 and a gantry tilt driving component 1132. The gantry body 1131 is hinged to the body part 1120. One end of the gantry tilt driving component 1132 is connected with the body part 1120, and the other end of the gantry tilt driving component 1132 is connected with the gantry body 1131. The gantry tilt driving component 1132 is communicated with the controller 150. The controller 150 is configured to indicate the gantry tilt driving component 1132 to drive the gantry body 1131 to move to adjust the fourth angle between the gantry body 1131 and the vertical direction Z. The angle detector 1110 may be on the gantry body 1131.

In the embodiment, by providing the angle detector 1110 on the gantry 1130, the fourth included angle between the gantry 1130 and the vertical direction Z is detected, such that the controller 150 can determine the included angle between the length direction of the forks 520 and the horizontal plane, and thus determine whether the gantry 1130 is tilted to be in place, thereby improving the intelligence degree of the handling device.

In an embodiment, the controller 150 is further configured to control, when, based on the 3D point cloud data, determining the second included angle between the fork insertion direction of the insertion holes 161 of the to-be-handled object 160 and the horizontal plane is greater than a preset tilt angle, the alarm 910 to give an alarm.

It should be noted that reference may be made to the above embodiments for the descriptions of the alarm 910 and no redundant descriptions are made herein. The preset tilt angle is a maximum angle (the angle between the fork insertion direction and the horizontal plane) at which the forks 520 being inserted into the insertion holes 161 of the to-be-handled object 160 do not collide with the to-be-handled object 160. When the second included angle is greater than the preset tilt angle, the forks 520 being inserted into the insertion holes 161 will collide with the to-be-handled object 160. At this time, the controller 150 may control the alarm 910 to give an alarm, such that the handling personnel knows the second included angle is greater than the preset tilt angle, and hence performs processing on the to-be-handled object 160 to make the second included angle to be less than or equal to the preset tilt angle. In this way, the forks 520 of the handling device can be inserted into the insertion holes 161. In some embodiments, when the second included angle between the fork insertion direction of the insertion holes 161 of the to-be-handled object 160 and the horizontal plane is greater than the preset tilt angle, and the third included angle a3 between the upper surface of the fork 520 and the placement direction of the to-be-handled object 160 is greater than the preset angle, the controller 150 can control the alarm 910 to perform different alarming operations, such that the handling personnel can determine that the second included angle is greater than the preset tilt angle or the third included angle a3 is greater than the preset angle. It can be understood that the preset tilt angle can be set based on the height h1 of the insertion holes 161 of the to-be-handled object 160 in the vertical direction Z, and the thickness h2 of the forks 520, and no limitation is made herein.

In the embodiment, the controller 150 can control, when determining the second included angle is greater than the preset tilt angle, the alarm 910 to give an alarm, such that the handling personnel knows the second included angle is greater than the preset tilt angle, and thus performs processing on the to-be-handled object 160 to make the second included angle to be less than or equal to the preset tilt angle. In this way, the forks 520 can be inserted into the insertion holes 161.

In an embodiment, the handling device may include a signal transmitter on the device body 110. Illustratively, the signal transmitter is at a side of the body part 1120 of the device body 110. The signal transmitter may be configured to send a signal to a charging device to indicate the charging device to charge the device body 110.

It should be noted that the charging device may be provided with a signal receiving module. When the signal receiving module of the charging device receives the transmitted signal from the signal transmitter of the handling device, it indicates that the handling device is in a charging region and needs to be charged. At this time, the charging device can charge the handling device to realize automatic charge for the handling device. In some embodiments, the signal transmitter may include a photoelectric transmitter and the signal receiving module may be a photoelectric receiver.

In an embodiment, the handling device may include a contour indicating lamp on the top of the body part 1120 in the vertical direction Z. The contour indicating lamp is configured to indicate a contour of the body part 1120. It should be noted that the contour indicating lamp may be configured to transmit light to indicate the contour of the body part 1120, for example, indicate the height, width or length of the body part 1120. In the embodiment, by providing the contour indicating lamp on the handling device, it can play a reminder role, avoid collision between other handling device or staff and the handling device, thereby increasing the safety level. In some embodiments, the contour indicating lamp on the handling device is a straight line contour indicating lamp. In some embodiments, the handling device may include one or two or three contour indicating lamps.

In an embodiment, with continuous reference to FIG. 11, the handling device may include a trigger 1140 communicated with the controller 150. The controller 150 can be configured to control, in response to detecting a trigger operation on the trigger 1140, the handling device to stop moving. In the embodiment, by providing the trigger 1140, the handling personnel can indicate the controller 150 by triggering the trigger 1140 to control the handling device to stop moving, thereby increasing the safety of the handling device. In some embodiments, the trigger 1140 may include a button and the trigger operation may include pressing the button. In some embodiments, there are two triggers 1140, both of which are communicated with the controller 150. The two triggers 1140 are respectively at both sides of the body part in the width direction Y. In this way, the convenience of the handling personnel to trigger the trigger 1140 can be improved.

In an embodiment, the handling device may include a transparent rainproof vehicle cover covered on the outer side of the body part 1120. In the embodiment, the rainproof vehicle cover is covered on the outer side of the body part 1120 to protect the body part 1120 and the modules inside the body part 1120, so as to increase the positioning reliability of the handling device.

In an embodiment, as shown in FIG. 12, there are mounting holes1210 on the body part 1120, the mounting holes1210 are used for detachably connection of an anti-collision strip 1220. In the embodiment, the mounting holes 1210 matching the anti-collision strip 1220 are provided on the body part 1120, such that in a case of need for disposing the anti-collision strip 1220, the anti-collision strip 1220 can be directly mounted to the body part 1120 through the mounting holes 1210, thus improving the use flexibility of the anti-collision strip 1220.

In an embodiment, the handling device may also include a gyro on the handling device and configured to detect a movement state of the handling device. The controller 150 is communicated with the gyro, and the controller 150 can position, based on the movement state of the handling device, the handling device.

In the descriptions of the specification, descriptions of the reference terms such as “some embodiments,” “other embodiments,” “ideal embodiments” and the like mean that the specific features, structures, materials or characteristics described in combination with the embodiments or examples are included in at least one embodiment or example of the application. In the present specification, the illustrative descriptions for the above terms do not necessarily refer to the same embodiments or examples.

Various technical features of the above embodiments can be arbitrarily combined. In order to make the descriptions concise, all possible combinations of the above various technical features in the above embodiments are not described. However, the combinations of these technical features shall, in case of no conflicts, be deemed to be within the scope recorded in the specification.

The above embodiments are only used to illustrate several implementations of the application. The detailed descriptions of these implementations shall not be understood as limiting of the application. It should be pointed out that those skilled in the arts can also make various variations and improvements without departing from the idea of the application and these variations and improvements all fall within the scope of protection of the application. Therefore, the scope of protection of the application shall be indicated by the appended claims.

What is claimed is:

1. A handling device, comprising:
a device body;
a fork assembly movably disposed on the device body and configured to pick up a to-be-handled object;
a three-dimensional, 3D, laser radar on the fork assembly, and configured to collect 3D point cloud data of the to-be-handled object;
a camera on the fork assembly and configured to collect image data of the to-be-handled object; and
a controller communicated with the 3D laser radar, the camera and the fork assembly respectively, and configured to respectively determine, based on the 3D point cloud data and the image data, pose information and a fork insertion position of the to-be-handled object to control the fork assembly to move, so as to enable the fork assembly to align with the fork insertion position of the to-be-handled object.

2. The handling device of claim 1, wherein
the fork insertion position of the to-be-handled object has at least one insertion hole;
the fork assembly comprises a movable component and at least one fork connected to the movable component;
the movable component is movably disposed on the device body and communicated with the controller, and is configured to drive the at least one fork to move relative to the device body;
the at least one fork is configured to be inserted into the at least one insertion hole; and
the 3D laser radar and the camera are both on the movable component and below the at least one fork in a vertical direction.

3. The handling device of claim 2, wherein a scanning region of the 3D laser radar comprises a first region corresponding to a travel road surface ahead of a front end of the handling device;
the controller is further configured to determine, based on the 3D point cloud data, whether a suspended position is present in the first region, wherein the first region is a road surface region in a region where an end of the device body connected with the movable component is located.

4. The handling device of claim 2, wherein each of the at least one fork comprises a root part close to the movable component and an end part away from the movable component;
a scanning region of the 3D laser radar comprises a second region where the root part of the fork is located and a third region corresponding to the end part of the fork, the third region comprises a region where the end part of the fork is located and a region ahead of the end part, and the ahead of the end part is a side of the end part away from the root part; and
the controller is further configured to determine, based on the 3D point cloud data, position information of the to-be-handled object and position information of the fork.

5. The handling device of claim 4, wherein the handling device further comprises a raising and lowering device on the movable component and connected with the 3D laser radar, wherein the raising and lowering device is configured to drive the 3D laser radar to move relative to the at least one fork in the vertical direction, to make the 3D laser radar to move to above the at least one fork in the vertical direction, such that the scanning region of the 3D laser radar comprises the second region and the third region.

6. The handling device of claim 2, wherein the movable component comprises a lateral movable component and a raising and lowering component; wherein the raising and lowering component is movably disposed on the device body and movable relative to the device body in the vertical direction, and the lateral movable component is on the raising and lowering component; the 3D laser radar and the camera are both on the raising and lowering component, the at least one fork is on the lateral movable component, and the at least one fork is driven by the lateral movable component to move in a width direction of the device body; and
the controller is communicated with the lateral movable component and the raising and lowering component, the controller is configured to determine, based on the 3D point cloud data and the image data, a height position of the at least one insertion hole of the to-be-handled object in the vertical direction, and control the raising and lowering component to move relative to the device body in the vertical direction, so as to drive the at least one fork to move in the vertical direction to the height position of the at least one insertion hole; the controller is further configured to control the lateral movable component to drive the at least one fork to move in the width direction, and determine, based on the 3D point cloud data, a movement distance of the at least one fork in the width direction.

7. The handling device of claim 6, wherein there are two forks, and the lateral movable component comprises a first slide block, a second slide block, a first guideway, a second guideway, a first driving component and a second driving component;
wherein the first slide block and the second slide block are both slidably connected with the first guideway, the first slide block is connected with one of the two forks, and the second slide block is connected with the other of the two forks; and
the first guideway is slidably connected with the second guideway; the first driving component is connected with the first slide block and the second slide block, and the first driving component is configured to drive the first slide block and the second slide block to slide along the first guideway; the second driving component is connected with the first guideway and configured to drive the first guideway to slide along the second guideway; and the first driving component and the second driving component are both communicated with the controller.

8. The handling device of claim 7, wherein there are two insertion holes, the controller is further configured to determine, based on the 3D point cloud data, lateral movable positions of the two insertion holes of the to-be-handled object to control the first driving component to drive the first slide block and/or the second slide block to slide along the first guideway, and to drive the two forks to slide, so as to adjust a first distance between the two forks, and/or,
the controller is further configured to control the second driving component to drive the first guideway to slide along the second guideway to entirely adjust positions of the two forks in the width direction, such that the positions of the two forks in the width direction correspond to the lateral movable positions of the two insertion holes.

9. The handling device of claim 2, wherein there are two forks disposed in a spacing on the movable component, and the 3D laser radar and the camera are between the two forks and are arranged along the vertical direction.

10. The handling device of claim 2, wherein,
the movable component comprises a rotator and/or a raising and lowering component, the raising and lowering component is movably disposed on the device body and is movable relative to the device body in the vertical direction, and the rotator is rotatably connected to the raising and lowering component, wherein the 3D laser radar and the camera are both on the raising and lowering component, the at least one fork comprises two forks, the two forks are on the rotator, and the two forks are driven by the rotator to rotate;
the controller is communicated with the rotator and the raising and lowering component, and the controller is configured to determine, based on the 3D point cloud data and the image data, a height position of the at least one insertion hole of the to-be-handled object in the vertical direction, and control the raising and lowering component to move relative to the device body in the vertical direction, so as to drive the two forks to move in the vertical direction to the height position of the at least one insertion hole, and/or,
the controller is configured to determine, based on the 3D point cloud data, a third included angle between a placement direction of the to-be-handled object and an upper surface of the two forks, and control, based on the third included angle, the rotator to rotate, and to drive the two forks to rotate, so as to make the third included angle between the upper surface of the two forks and the placement direction to be less than or equal to a preset angle; the placement direction of the to-be-handled object is parallel to a contact surface between the to-be-handled object and the two forks and perpendicular to a fork insertion direction of the at least one insertion hole.

11. The handling device of claim 2, wherein the handling device further comprises an alarm communicated with the controller; and
the controller is configured to control, when determining, based on the 3D point cloud data, the third included angle between a placement direction of the to-be-handled object and an upper surface of the at least one fork is greater than a preset angle, the alarm to give an alarm, wherein the placement direction of the to-be-handled object is parallel to a contact surface between the to-be-handled object and the at least one fork and perpendicular to a fork insertion direction of the at least one insertion hole.

12. The handling device of claim 2, wherein the handling device further comprises an alarm communicated with the controller; and
the controller is configured to control, when determining, based on the 3D point cloud data, a second included angle between a fork insertion direction of the at least one insertion hole of the to-be-handled object and a horizontal plane is greater than a preset tilt angle, the alarm to give an alarm; wherein the preset tilt angle is a maximum angle that the at least one fork does not collide with the to-be-handled object in a process of inserting the at least one fork into the at least one insertion hole of the to-be-handled object.

13. The handling device of claim 2, wherein the device body comprises a body part and a gantry movably disposed on the body part, and the fork assembly is movably disposed on the gantry; and
the controller is communicated with the gantry, and the controller is configured to determine, based on the 3D point cloud data, a second included angle between a fork insertion direction of the at least one insertion hole of the to-be-handled object and a horizontal plane, and control the gantry to move, such that an included angle between a length direction of the at least one fork and the horizontal plane is consistent with the second included angle.

14. The handling device of claim 13, further comprising an angle detector on the gantry, wherein the angle detector is communicated with the controller, and the angle detector is configured to detect a fourth included angle between the gantry and the vertical direction, and the controller is configured to determine the fourth included angle by the angle detector to determine whether the gantry is tilted to be in place.

15. The handling device of claim 14, wherein one end of the angle detector is connected with the gantry, and the other end of the angle detector is connected with the body part; the angle detector is configured to perform extension or retraction along with forward or backward tilt of the gantry; and determine, based on an extension or retraction length of the angle detector, the fourth included angle between the gantry and the vertical direction.

16. The handling device of claim 13, wherein the gantry comprises a gantry body and a gantry tilt driving component; the gantry body is hinged to the body part; one end of the gantry tilt driving component is connected with the body part, and the other end of the gantry tilt driving component is connected with the gantry body; the gantry tilt driving component is further communicated with the controller, and the controller is further configured to indicate the gantry tilt driving component to drive the gantry body to move, so as to adjust the fourth included angle between the gantry body and the vertical direction.

17. The handling device of claim 2, further comprising a height detection sensor, wherein the height detection sensor is communicated with the controller, and the height detection sensor is on the at least one fork or on a raising and lowering component of the movable component, and configured to detect a height of the at least one fork in the vertical direction.

18. The handling device of claim 5, wherein the raising and lowering device comprises a push rod that is able to raise and fall and configured to drive the 3D laser radar to move relative to the at least one fork in the vertical direction.

19. The handling device of claim 2, wherein the movable component comprises a rotary table configured to drive the at least one fork to rotate around an axis of the rotary table.

20. The handling device of claim 1, wherein,
in response to that the 3D laser radar is at a first position, the controller is configured to respectively determine, based on the 3D point cloud data and the image data, the pose information and the fork insertion position of the to-be-handled object to control at least one fork of the fork assembly to move, so as to make the fork assembly to move to the fork insertion position of the to-be-handled object, and control the handling device to perform anti-fall function; and
in response to that the 3D laser radar is at a second position, the controller is configured to perform, based on the 3D point cloud data and the image data, an end safety protection of the at least one fork of the fork assembly and a horizontal in-place detection of the to-be-handled object.
